(19) United States
(12) Patent Application Publication
(10) Pub. No.: US 2013/0208256 A1
(43) Pub. Date: Aug. 15, 2013

(54) LDV with Diffractive Optical Element for Transceiver Lens

(71) Applicants: Priyavadan MAMIDIPUDI, Bristow, VA (US); Elizabeth A. Dakin, Great Falls, VA (US); Philip L. Rogers, Hume, VA (US); Daniel C. Dakin, Great Falls, VA (US); Rupak Changkakoti, Haymarket, VA (US); Lance Leclair, Manassas, VA (US)

(72) Inventors: Priyavadan MAMIDIPUDI, Bristow, VA (US); Elizabeth A. Dakin, Great Falls, VA (US); Philip L. Rogers, Hume, VA (US); Daniel C. Dakin, Great Falls, VA (US); Rupak Changkakoti, Haymarket, VA (US); Lance Leclair, Manassas, VA (US)

(73) Assignee: Optical Air Data Systems, LLC., Manassas, VA (US)

(21) Appl. No.: 13/473,107

(22) Filed: May 16, 2012

Related U.S. Application Data
(60) Provisional application No. 61/597,598, filed on Feb. 10, 2012.

(51) Int. Cl. G01C 3/08; G02B 27/09

(52) U.S. Cl. CPC G01C 3/08; G02B 27/0927
USPC 356/4.01; 359/15

(57) ABSTRACT

A transceiver device that includes one or more light sources configured to emit a light beam that includes one or more different wavelengths, and includes a diffractive optical element configured to initiate one or more wavelength specific responses from the light beam to form one or more transmission light beams and to direct the one or more transmission light beams substantially towards a target; and further includes one or more sensor devices configured to receive the one or more transmission light beams and one or more reception light beams that are reflected back from the target. The diffractive optical element (e.g., a holographic element) is used in either a monostatic, bistatic or multistatic design to reduce the required size and/or number of optical elements, lasers and receivers. The transceiver device may be used in a LIDAR system in order to measure air and wind parameters at multiple altitudes.

### CROSS REFERENCE TO RELATED APPLICATIONS

This patent application claims the benefit of U.S. Provisional Patent Application No. 61/597,598, filed Feb. 10, 2012, which is incorporated herein by reference in its entirety.

### BACKGROUND

1. Field of the Invention

The invention relates generally to a Light Detection and Ranging (LIDAR) system, and more specifically to a LIDAR system with a diffractive optical element (DOE) for use in a transceiver lens.

2. Related Art

Conventional LIDAR systems include a laser source, transmitter optics, receiver optics, opto-electronic receivers, and processing electronics. The transmitter and receiver optics can be a single device (known as a monostatic configuration), or separate packages placed next to one another (known as a bistatic configuration). LIDAR systems in either configuration can be used as direct detection or coherent detection sensors. Direct detection LIDAR sensors are designed to measure the intensity of light scattered back from the target to determine the movement and characteristics of the target. Alternately, coherent detection is a more sensitive technique designed to evaluate the signals scattered back from the target against the transmitted laser signal to determine the movement and other characteristics of the target.

Typically, conventional designs for these LIDAR systems can involve multiple optical elements, e.g., multiple transmitters and/or multiple receivers. In particular, the optical elements generally include any number of lenses, mirrors, optical filters, and/or prisms, which all take up considerable weight and space within the LIDAR system. Moreover, separate optical elements (separate lenses, mirrors, prisms, and filters) are required for separate tasks, such as focusing, reflecting, bending, and filtering light, to provide some examples. The multiplicity of components further contributes to weight and bulk of conventional LIDAR systems, and of course impacts design and manufacturing costs as well. Also, when using multiple optical elements, alignment of each element relative to one another can become a problem after multiple uses of the sensor.

Thus, there is a need for an alternative to these conventional transceivers, which can be utilized to reduce the relative size and weight of LIDAR systems, while maintaining reliability, such that the systems are sufficiently versatile and compact to be readily deployed to field locations, airborne platforms, and can be used in handheld devices.

### BRIEF DESCRIPTION OF THE DRAWINGS/FIGURES

Embodiments of the invention are described with reference to the accompanying drawings. In the drawings, like reference numbers indicate identical or functionally similar elements. Additionally, the left most digit(s) of a reference number identifies the drawing in which the reference number first appears.

FIG. 1 is a block diagram of a transceiver device having a diffractive optical element (DOE) according to an exemplary embodiment of the invention;

FIG. 2 is a schematic diagram of a multi-element DOE system according to an exemplary embodiment of the invention;

FIG. 3 is a diagram showing an optical system for converting a Gaussian light beam to a Bessel light beam according to an exemplary embodiment of the present disclosure; and

FIG. 4 is a flowchart of exemplary operational steps of converting a Gaussian light beam into one or more Bessel light beams according to an exemplary embodiment of the present invention.

The invention will now be described with reference to the accompanying drawings. In the drawings, like reference numbers generally indicate identical, functionally similar, and/or structurally similar elements. The drawing in which an element first appears is indicated by the leftmost digit(s) in the reference number

### DETAILED DESCRIPTION

The present disclosure describes exemplary embodiments of a transceiver device having a diffractive optical element (DOE), with reference to the accompanying drawings. In one such exemplary embodiment, the DOE may represent a holographic optical element (HOE). Additionally, the HOE may be used as a transceiver optic in a monostatic, a bistatic, or a multistatic design to reduce the required size and/or number of optical elements (e.g., lasers and receivers). Further, the transceiver device may be used in a Light Detection and Ranging (LIDAR) system to measure air and wind parameters at multiple altitudes.

This Detailed Description refers to accompanying drawings that illustrate exemplary embodiments consistent with the invention. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the invention. Therefore, the Detailed Description is not meant to limit the invention. Rather, the scope of the invention is defined only in accordance with the following claims and their equivalents.

In particular, embodiments of the present disclosure are described in the context of an LIDAR system having a DOE, e.g., a holographic optical element. Persons skilled in the relevant arts will recognize that the elements, methods, techniques, and principles of the present invention may be applied, with suitable modifications, to other kinds of optical systems as well as other kinds of optical elements for use therein.

An embodiment of the present disclosure provides an optical system based on HOEs. An HOE may be tuned to diffract, reflect, focus, select, filter, and/or collimate light at a particular wavelength or within a narrow band of wavelengths. A single HOE may have different effects on different wavelengths, for example, allowing one or more wavelengths of light to pass through unimpeded, while blocking, reflecting, or deflecting light at one or more dissimilar wavelengths, to provide some examples. In some embodiments, an HOE may also be configured to modify the modal content of an incoming beam of light. For example, an HOE may convert a laser beam with multiple transverse (TEM) modes into a single transverse (TEM) mode.

A single HOE may also perform a number of optical tasks, which would normally require several discrete optical elements of a conventional nature. For example, a single HOE may serve as both a prism and a filter (for example, by redirecting light of one wavelength, while completely blocking light at another wavelength), to provide an example. A single HOE may function selectively in one way on a particular wavelength or narrow band of wavelengths, while functioning in a different way on all other wavelengths which fall outside the particular wavelength or narrow band of wavelengths.

Additionally, a combination of HOEs may be used to perform some or all of the necessary optical processing tasks of the transceiver device. For example, a first HOE, in conjunction with light from a source of illumination, may serve to generate or collect a distinctive pattern of light, while a second HOE may serve to focus the pattern of light, or otherwise redirect the pattern of light so obtained, towards an optical sensor for image collection and processing.

A person having ordinary skill in the relevant art(s) will understand that the term “holographic optical element,” as used throughout this disclosure, refers to an optical element or elements that can interact with and influence light using physical structures conventionally associated with the art of holography. Such elements may be comprised of materials such as glass, plastic, photographic emulsions, gelatins, photoresists, photothermoplastics, various polymers, photorefractive crystals, semiconductors, and metals, or combinations thereof, to provide some examples; however other materials may be used without departing from the spirit and scope of the present disclosure.

HOEs may exhibit wavelength-specific responses to light including, for example and without limitation, reflecting light at some wavelengths, while transmitting light at other wavelengths, selectively reflecting, diffracting, or transmitting light at different angles depending on the wavelength of the light, selectively filtering light depending on the wavelength of the light, and exhibiting other wavelength-specific behaviors well known in the art of holography. In short, HOEs may function as wavelength-specific mirrors, lenses, filters, refractors, or diffractors, to provide some examples. The holographic features of such elements may be implemented via various structures including, for example and without limitation, phase gratings, amplitude gratings, various forms of layered construction, optical coatings, and substrates.

This Detailed Description of exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the invention. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Although the invention is described in terms of LIDAR systems, those skilled in the relevant art(s) will recognize that the present invention may be applicable to other optical systems and methods for using the same, without departing from the spirit and scope of the present invention.

### An Exemplary Transceiver Device

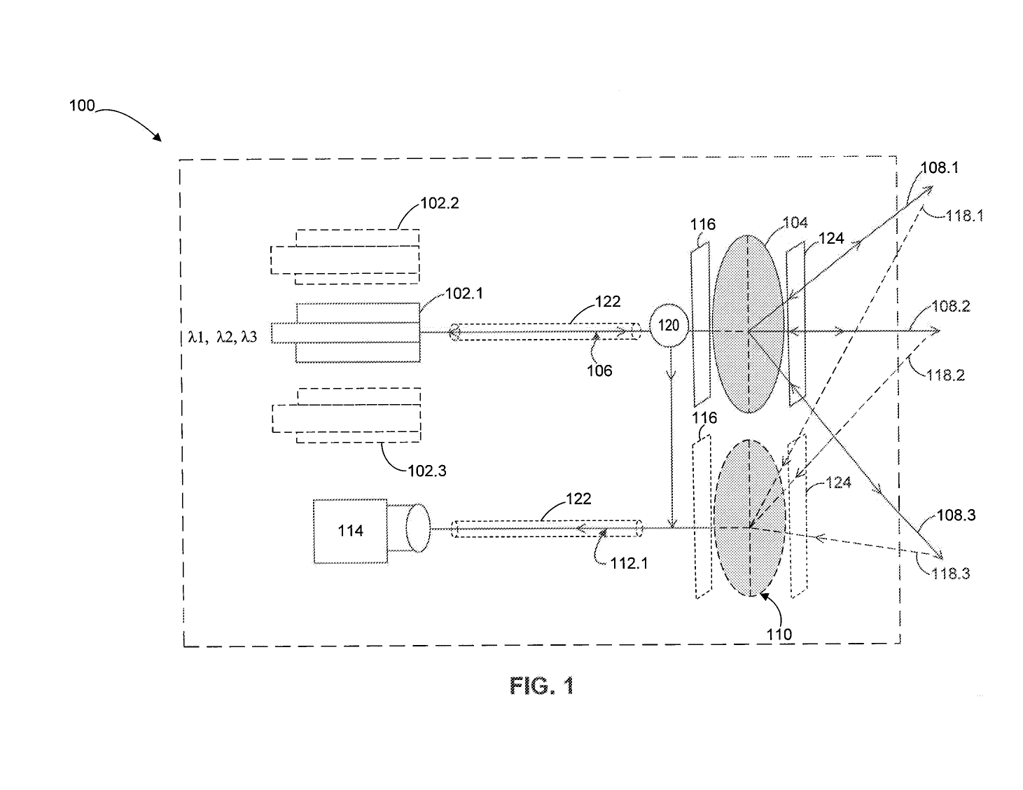

FIG. 1 is a block diagram of a transceiver device having a DOE according to an exemplary embodiment of the present disclosure.

In an exemplary embodiment, a transceiver device 100 may be configured to be implemented within an LIDAR system, to provide an example. However, the LIDAR system is provided for illustrative purposes only, and those skilled in the relevant art(s) will recognize that the transceiver device 100 may be implemented within other optical systems without departing from the spirit and scope of the present disclosure.

If used in a LIDAR system, it may be a handheld LIDAR system or vehicle-mounted LIDAR for either land based or airborne measuring (e.g., ground speed, air speed, various wind characteristics, etc.). For example, when used in a vehicle-mounted system, due to the reduced size of the optics required for the embodiments disclosed, any required openings made in the vehicle for transmission/reception of a light beam are substantially reduced.

In one example, transceiver device 100 includes a light source 102.1. The light source 102.1 may be configured to emit a light beam 106 at a plurality of different wavelengths, such as λ1, λ2 and λ3. These various wavelengths may be split along various light paths using a beam splitter 126 (not shown in FIG. 1) located downstream of the light source 102.1 In an exemplary embodiment, the transceiver device 100 may include a plurality of light sources 102.1, 102.2 and 102.3. In such an exemplary embodiment, each of the plurality of light sources 102.1, 102.2 and 102.3 may emit light at a different wavelength to prevent interference of the emitted light beams. Additionally, to prevent interference of each of the emitted light beams, each of the plurality of light sources 102.1, 102.2 and 102.3 may emit light at a different angle. In other examples, the beams may be directed through waveguides 122 between the light source 102.1 (or beam splitter 126) and down-stream optical elements. As will be appreciated by a skilled artisan, various configurations of the above can be used without departing from the scope of the present invention.

In this example, the transceiver device 100 also includes a diffractive optical element (DOE). For example, a DOE is a phase relief structure that works on the principles of diffraction. The light source 102.1 is configured to emit the light beam 106 in a direction that is substantially towards the DOE. In an exemplary embodiment, the DOE may represent a holographic optical element (HOE) 104. As discussed previously in this document, the HOE 104 may refer to an optical element or elements that can interact with and influence light using physical structures conventionally associated with the art of holography. Additionally, the HOE 104 may show wavelength-specific responses to light including, for example and without limitation, reflecting light at some wavelengths, while transmitting light at other wavelengths, selectively reflecting, diffracting, or transmitting light at different angles depending on the wavelength of the light, selectively filtering light depending on the wavelength of the light, and exhibiting other wavelength-specific behaviors well known in the art of holography. Therefore, the HOE 104 is capable of creating nearly limitless beam shapes in multiple working phases.

In an exemplary embodiment, the HOE 104 may include a plurality of different portions. Each of the plurality of different portions may have different holographic properties, such that the incoming light beam 106 reacts differently depending on which portion of the HOE 104 the light beam 106 interacts with. Therefore, the single HOE 104 can invoke a plurality of different response simultaneously. Additionally, in another exemplary embodiment, the transceiver device 100 may include a plurality of HOEs (not shown in FIG. 1). In such an exemplary embodiment, each of the plurality of HOEs may be configured to have different holographic properties, such that each of the plurality of HOEs exhibit different wavelength-specific reactions in response to receiving the emitted light beam 106 from the light source 102.1. For example, a transmit and receive path may use a separate holographic optimal elements, where each of the separate holographic optical elements are designed to most optimally transmit and receive the light beam(s).

The precise wavelength-specific response that is invoked by the HOE 104 is design specific. Therefore, once the incoming light beam 106 contacts the HOE 104, any one of the aforementioned responses, or combinations thereof, may be invoked by the HOE 104. In an exemplary embodiment, once the light beam 106 contacts the HOE 104, the light beam 106 is diffracted at different angles depending on the wavelength of the light beam 106, to provide an example; however other responses are possible without departing from the spirit and scope of the present disclosure. In an exemplary embodiment, the incoming light beam 106 is split into three different transmission beams 108.1, 108.2 and 108.3. Each of the transmission beams 108.1, 108.2 and 108.3 are transmitted out from the transceiver device 100 at three different angles, which can vary depending on the wavelengths contained in the light beam 106 and on the specific HOE 104 being implemented. The transmission beams 108.1, 108.2 and 108.3 then interact with the surrounding environment to determine a plurality of different environmental factors. These environmental factors may include air and wind parameters, range (from a range of zero to approximately several hundred meters) and/or velocity, to provide some examples; however other environmental factors may be calculated without departing from the spirit and scope of the present disclosure. The HOE 104 functioning to split the light beam 106 into transmission beams 108.1, 108.2 and 108.3 is provided for illustrative purposes only, and it is not intended to be the only wavelength-specific response capable of being used herein, and is not meant to limit this disclosure. In particular, any wavelength-specific response that is capable of being invoked by the DOE may be used.

After the transmission beams 108.1, 108.2 and 108.3 interact with their respective surrounding elements, one or more reception beams 118.1, 118.2 and 118.3 are received at the transceiver device 100. Upon receipt, the reception beams 118.1, 118.2 and 118.3 may interact with a second DOE. In an exemplary embodiment, the second DOE may include a receipt HOE 110, to provide an example. The receipt HOE 110 may represent an exemplary embodiment of the HOE 104. Therefore, the receipt HOE 110 may perform similar functions to those described with respect to the HOE 104. In an exemplary embodiment, the receipt HOE 110 may diffract each of the reception beams 118.1, 118.2 and 118.3 such that they form a return light beam 112.1. The receipt HOE 110 may also direct the return light beam 112.1 substantially towards a sensor device 114. In some embodiments, the light beam 106, the transmission light beams 108.1, 108.2 and 108.3, and the reception light beams 118.1, 118.2 and 118.3 may each comprise one or more different wavelengths. For example, the light beam 106 (λ1, λ2 and λ3), the transmission light beams 108.1, 108.2 and 108.3, and the reception light beams 118.1, 118.2 and 118.3 may include one or more wavelengths in the range of approximately 800 nanometers to approximately 2100 nanometers.

In an exemplary embodiment, after the transmission beams 108.1, 108.2 and 108.3 interact with their respective surrounding elements, each of the reception beams 118.1, 118.2 and 118.3 may again interact with the HOE 104, rather than interact with the receipt HOE 110. The HOE 104 may then diffract each of the reception beams 118.1, 118.2 and 118.3 such that they form a second return light beam 112.2 (not shown in FIG. 1). In an exemplary embodiment, the second return light beam 112.2 may travel along the same path and in an opposite direction as the light beam 106. Thus, the sensor device 114 and the light source 102.1 may be collocated. Further, in an exemplary embodiment, the light source 102.1 and the sensor device 114 may comprise a single device.

In one example, an optical directive element 120 can be positioned between a last optical element in a transmission path/first optical element in a reception path and the HOE 104. When in a first mode, the optical directive element 120 allows for transmission of the transmission beams 108.1, 108.2 and 108.3 along the transmission path through the HOE 104. When in a second mode, the optical directive element 120 allows for directing of the reception beams 118.1, 118.2 and 118.3 along a receive path to the sensor device 114.

The enumerated configurations of the light source 102.1, the HOE 104, the receipt HOE 110 and the sensor device 114 are provided for illustrative purposes only, and they are not intended to be the only configurations capable of being used herein, and are not meant to limit this disclosure. In particular, any configuration that meets the specifications described in this disclosure may be used. In particular, the transceiver device 100 may include a plurality of receipt HOEs 110, each being configured to receive one of the reception beams 118.1, 118.2 or 118.3. Also, the transceiver device 100 may include a plurality of sensor devices 114, each being configured to invoke a specific response on one of the reception beams 118.1, 118.2 or 118.3. Further, specific configurations of the light source 102.1, the HOE 104, the receipt HOE 110 and the sensor device 114 are design specific.

Accordingly, the transceiver device 100 may be configured to have a monostatic design (where a transmitter (e.g., the light source 102.1) and a receiver (e.g., the sensor device 114) are collocated), a bistatic design (where the transmitter and the receiver are separated by a distance that is comparable to an expected target distance), or a multistatic design (where there exists at least three components, either one receiver and two transmitters, two receivers and one transmitter, or multiple receivers and multiple transmitters).

In an exemplary embodiment, the transceiver device 100 may also include one or more filters 116. The filters 116 may be used to filter out ambient light, which could potentially interfere with desired wavelengths of light at the sensor device 114. In an exemplary embodiment, the filters 116 may be used to filter out specific wavelengths contained within the light beam 106. Accordingly, the light source 102.1 may emit white light towards the filters 116, and the filters 116 may include a color wheel filter such that only a specific color of light (a specific wavelength) is allowed to reach the HOE 104. However, the light source 102.1 emitting white light, and the corresponding color wheel filter are provided for illustrative purposes only, and are not intended to be the only light-filter combinations capable of being used herein, and is not meant to limit this disclosure. In particular, any filter that is capable of separating incoming light based on its wavelength may be used.

Additionally, the transceiver device 100 may include one or more lenses 124. The lenses 124 may be used to properly direct the transmission beams 108.1, 108.2 and 108.3 when they are reflecting off of the HOE 104, or when the reception beams 118.1, 118.2, 118.3 are received at the receipt HOE 110. This can be done to more effectively direct the return light beam 112.1 towards the sensor device 114. Further, in an exemplary embodiment, a quality of the reception beams 118.1, 118.2 or 118.3 may be degraded, for example because of possible diffuse ambient light. In such an exemplary embodiment, the lenses 124 may process the reception beams 118.1, 118.2 or 118.3 to allow the return light beam 112.1 to become focused, magnified, and/or reduced, as it is captured by the sensor device 114.

In another example, the transceiver device 100 may include light waveguides 122 (e.g., fiber optics) to direct light between optical elements associated with the light source 102.1 (transmitter path) and the sensor device 114 (received path). In a still further example, one or more of the elements discussed above may be formed as a photonic integrated circuit, or the like, e.g., as described in U.S. application Ser. No. ______, filed ______, entitled “Optical Electric Integrated Circuits” (Attorney Docket No. 2996.0360000).

Additionally, as discussed previously in this document, the HOE 104 and the receipt HOE 110 may have different effects on different wavelengths, for example, allowing one wavelength of light to pass through unimpeded, while blocking, reflecting, or deflecting light at a different wavelength. Therefore, a single HOE 104 and/or a single receipt HOE 110 may perform a number of optical tasks, which would normally be performed by several discrete optical elements of a conventional nature. Consequently, implementing HOEs within the transceiver device 100 ultimately reduces the required size and weight of the transceiver device 100 by reducing the required number of optical elements (light sources 102.1, 102.2 and 102.3, DOEs, and sensor devices 114). Thus, the transceiver device 100 is sufficiently versatile and compact to be readily deployed to field locations and used in handheld devices.

Further, the transceiver device 100 is sufficiently reliable to be implemented within an LIDAR system, which can then be used to assist in the landing of manned and/or unmanned aircraft, or for collision avoidance in autonomous vehicles, to provide some examples; however the LIDAR system having the transceiver device 100 may be used to perform other functions without departing from the spirit and scope of the present disclosure. For example, LIDAR systems found in U.S. Pat. Nos. 5,272,513, 6,141,086, 7,068,355, 7,206,064, 7,898,435; U.S. application Ser. Nos. 12/988,248, 12/084,849, 13/026,932, (2996.0450000, 0500000, and 0520000) may be modified to include one or more of the features discussed above, which applications and patents are incorporated by reference herein in their entireties.

### An Exemplary Multi-Element Doe System

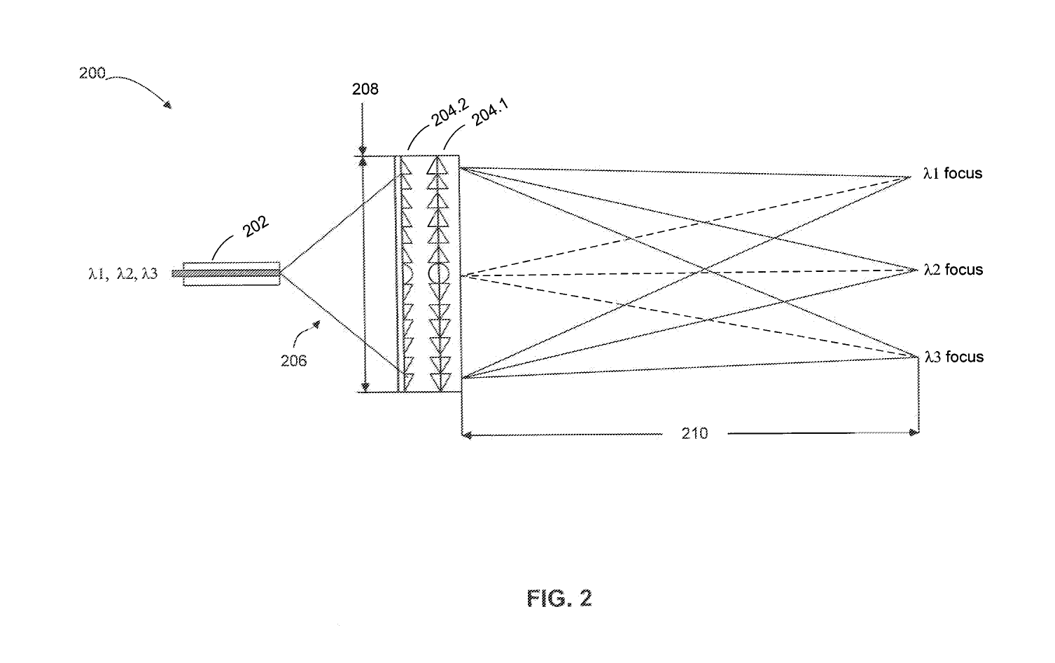

FIG. 2 is a schematic diagram of a multi-element DOE system according to an exemplary embodiment of the present disclosure.

A multi-element DOE system 200 includes a light source 202. The light source 202 may represent and exemplary embodiment of the light source 102.1. The light source 202 may be configured to emit a light beam 206 at a plurality of different operating wavelengths λ1, λ2 and λ3. The multi-element DOE system 200 also includes a first DOE 204.1 and a second DOE 204.2, which are configured to receive the light beam 206. In an exemplary embodiment, the DOEs 204.1 and 204.2 may be distributed in an array, such that the light beam 206 travels through each of the DOEs 204.1 and 204.2.

As discussed previously in this disclosure, a DOE is a phase relief structure that operates on the principle of diffraction. Such phase structures can be designed to multiplex-demultiplex different wavelengths as well as direct light and perform as a lens. Additionally, in an exemplary embodiment, multi-element structures can be sandwiched together to perform multiple functions, such as being used as a transmit aperture in a wind sensor application, to provide an example; however other applications are possible without departing from the spirit and scope of the present disclosure.

Additionally, the multi-element DOE system 200 is configured to avoid interference of the transmitted light beams by precisely selecting the operating wavelengths λ1, λ2 and λ3 and an aperture width 208 based on a selected focal distance 210. Further, the DOEs 204.1 and 204.2 are configured such that the light beam 206 will experience an angular deflection 212 (not shown in FIG. 2) that is consistent with the selected focal distance 210. In an exemplary embodiment, the operating wavelengths λ1, λ2 and λ3, the aperture width 208, the selected focal distance 210 and the angular deflection 212 may be selected according to Table 1. However, Table 1 is provided for illustrative purposes only, and those skilled in the relevant art(s) will recognize other optical and dimensional characteristics may be implemented within the multi-element DOE system 200 without departing from the spirit and scope of the present disclosure.

TABLE 1
Optical and Dimensional Characteristics

| Parameter | Symbol | Specification | Tolerance | Units | Comments |
|---|---|---|---|---|---|
| Operating | λ1, λ2, | 1535, 1545 and 1555 | +/−0.2 | nm | |
| Wavelength | λ3 | | | | |
| Center | λc1, λc2, | 1535, 1545 and 1555 | +/−0.2 | nm | |
| Wavelength | λc3 | | | | |
| Transmission | | 99.0 | | % | At 1535, |
| Efficiency | | | | | 1545 and |
| | | | | | 1555 |
| Wavelength | Δλ | 5 | +/−0.2 | nm | For each |
| Bandwidth | | | | | wavelength |
| Angular | | 7° | +/−0.1° | degrees | |
| Deflection 212 | | | | | |
| Focal Distance | | 50 | | meters | |
| 210 | | | | | |
| Damage | | >2 KW | | | |
| Threshold | | | | | |

Dimensional Specifications

| | | | |
|---|---|---|---|
| Aperture Width | 60 | +/−1 | Mm |
| 208 | | | |

Further, the multi-element DOE system 200 is configured to include precise absolute maximum ratings. In an exemplary embodiment, the absolute maximum ratings represent short-term conditions that the multi-element DOE system 200 can be subjected to over the course of operation without permanent degradation in performance and/or reliability. Therefore, the multi-element DOE system 200 must, at all times, meet a maximum storage temperature, and a maximum operating temperature, specified within the absolute maximum ratings. In an exemplary embodiment, the multi-element DOE system 200 may be configured to withstand storage temperatures in the range of approximately −60° C. to approximately 85° C., and operating temperatures in the range of approximately −60° C. to approximately 70° C. Additionally, in such an exemplary embodiment, the multi-element DOE system 200 is configured to meet all a predetermined standard (e.g., Mil-spec 883 F standards) for mechanical vibration, temperature, humidity and IP65 rating. The Mil-spec 883 F standards refer to the uniform methods, controls, and procedures for testing microelectronic devices suitable for use within Military and Aerospace electronic systems including basic environmental tests to determine resistance to deleterious effects of natural elements and conditions surrounding military and space operations, mechanical and electrical tests workmanship and training procedures and such other controls and constraints as have been deemed necessary to ensure a uniform level of quality and reliability suitable to the intended applications of those devices.

### An Exemplary System for Converting Gaussian Light to Bessel Light

In many instances in which an LIDAR system is used, it may be desirable to implement the LIDAR system using a Bessel light beam rather than a Gaussian light beam. For example, a true Bessel beam is non-diffractive, which means that as it propagates, it does not diffract and spread out. This non-diffractive characteristic of Bessel beams is in direct contrast to the usual behavior of light, which generally spreads out after being focused down to a small spot. Another characteristic of Bessel beams that makes them desirable for use in LIDAR systems, is that Bessel beams are self-healing, meaning that a Bessel beam can be partially obstructed at one point, but will re-form at a point further down the beam axis. Therefore, where an LIDAR system is being used to detect air and wind parameters, range, and/or velocity, it may be desirable to use a light beam that has the aforementioned self-hearing characteristics to ensure that there is little or no degradation of the light beam upon its receipt. However, true Bessel beams cannot be created as they are unbounded and would require an infinite amount of energy. Although, good approximations can be made, for example, using a system for converting a Gaussian light beam into a Bessel light beam. An explanation of basic conversion from Gaussian to Bessel light can be found in Synchronization of High-Dimensional Dynamic Systems, Elizabeth Anne Rogers, Doctor of Philosophy, 2005, which is incorporated by reference herein in its entirety.

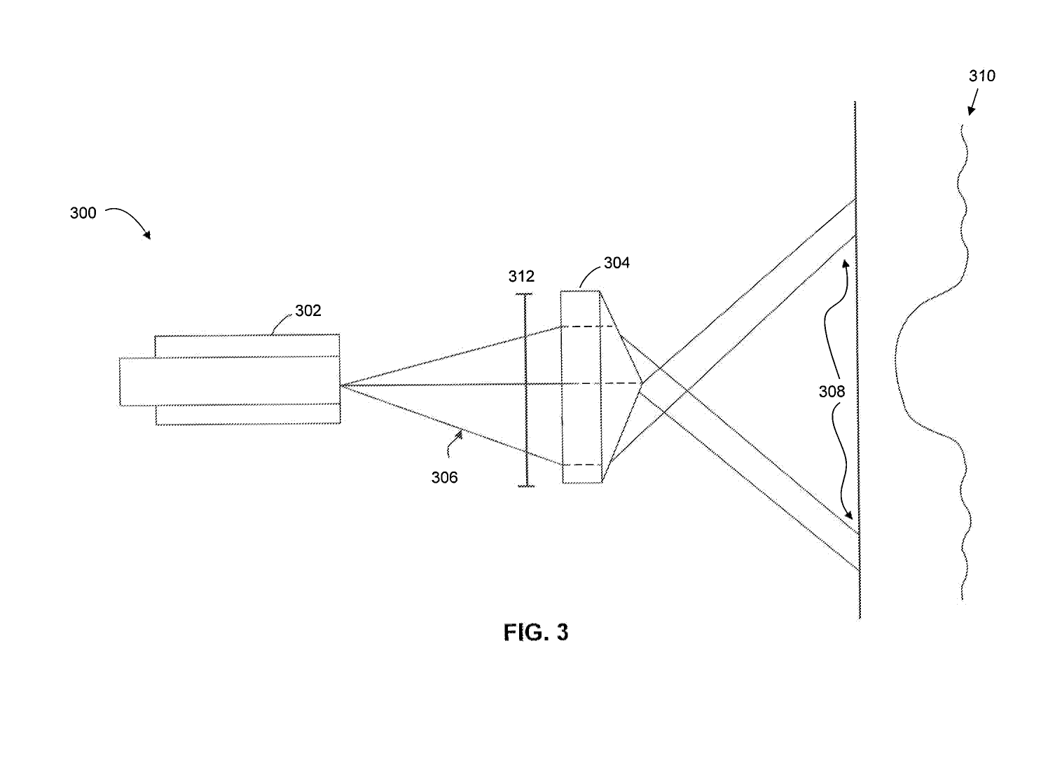

FIG. 3 is a diagram showing an optical system for converting a Gaussian light beam into a Bessel light beam according to an exemplary embodiment of the present disclosure.

An optical system 300 may include a light source 302, which may represent an exemplary embodiment of the light source 102.1. The light source 302 may be configured to emit a light beam 306. In an exemplary embodiment, the light beam 306 may include Gaussian light. Additionally, the optical system 300 may also include a DOE.

The light source 302 is configured to emit the light beam 306 in a direction that is substantially towards the DOE. In an exemplary embodiment, the DOE may represent an HOE 304. As discussed previously in this document, the HOE 304 may refer to an optical element or elements that can interact with and influence light using physical structures conventionally associated with the art of holography. Additionally, the HOE 304 may show wavelength-specific responses to light including, for example and without limitation, reflecting light at some wavelengths, while transmitting light at other wavelengths, selectively reflecting, diffracting, or transmitting light at different angles depending on the wavelength of the light, selectively filtering light depending on the wavelength of the light, and exhibiting other wavelength-specific behaviors well known in the art of holography.

In an exemplary embodiment, the HOE 304 may include substantially similar characteristics to an axicon, meaning that the HOE 304 may function like a specialized type of lens having a conical surface. In an exemplary embodiment, the HOE 304 may transform the light beam 306 into a ring configuration (Bessel beam 308). The Bessel beam 308 has an intensity that is represented by line 310. Line 310 shows that the intensity of the Bessel beam 308 is the highest at the center of the ring configuration, and that the intensity of the Bessel beam 308 diminishes as you traverse a distance away from the center of the ring. Additionally, the maximum diffraction-free propagation distance of the Bessel beam 308 can be calculated by finding the distance traversed from the center of the ring configuration when the critical point is the boundary of the aperture 312.

In an exemplary embodiment, the optical system 300 may be used to create multiple Bessel beams out of a single Gaussian beam. In such an exemplary embodiment, the HOE 304 may be divided into separate masks for each Bessel beam that needs to be created. Each of the separate masks can then be tiled. In an exemplary embodiment, multiple Bessel beams can also be formed by nesting multiple singularities within the single HOE 304.

Further, as a propagation distance of the Bessel beam 308 increases, the amount of laser power in a first ring of the Bessel beam 308 also increases. Thus, as the Bessel beam 308 travels further from the HOE 304, the singularity in the center of the Bessel beam 308 become less defined. Also, as the Bessel beam 308 propagates, the anomalous diffraction patterns diverge away from the center of the first order beam, making the Bessel beam 308 clearer. Therefore, the length that the Bessel beam 308 will propagate without diffraction is limited due to the size of the aperture 312.

In an exemplary embodiment, the optical system 300 allows for the creation of the Bessel beam 308 out of Gaussian beams with real time control over the size of the singularity and the deflection angle. Thus, using HOE 304 to create the Bessel beam 308 can allow for the intensity of the first ring of the Bessel beam 308 to be made to be significantly greater than an intensity of a Bessel beam created using a non-holographic element. For example, in an exemplary embodiment, an intensity of a first ring of a Bessel beam created using a 64 level grating may be approximately an order of magnitude greater than a first ring of a Bessel beam created using a binary mask (non-holographic optical element). Consequently, the optical system 300 having the HOE 304 allows for a more reliable Bessel beam 308 to be created, which in turn can be used to create a more reliable LIDAR system.

### An Exemplary Method of Converting a Gaussian Light Beam into One or More Bessel Light Beams

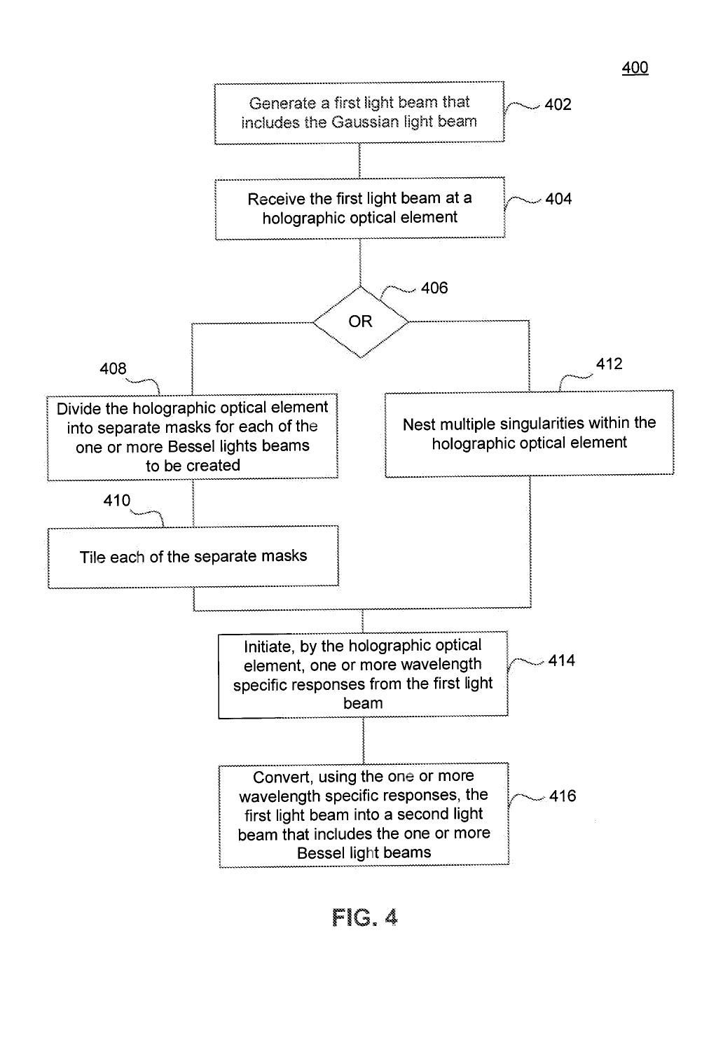

FIG. 4 is a flowchart of exemplary operational steps of converting a Gaussian light beam into one or more Bessel light beams according to an exemplary embodiment of the present invention. The disclosure is not limited to this operational description. Rather, it will be apparent to persons skilled in the relevant art(s) from the teachings herein that other operational control flows are within the scope and spirit of the present disclosure. The following discussion describes the steps in FIG. 4. The flowchart of FIG. 4 is described with reference to embodiments of FIG. 3. However, a method 400 is not limited to these embodiments.

The method begins at step 402 where the light beam 306 is generated by the light source 302. Additionally, the light beam 306 comprises Gaussian light.

The method then proceeds to step 404 where the light beam 306 is received at the HOE 304.

The method then proceeds to block 406 where a decision is made as to what technique will be implemented to create the one or more Bessel light beams 308. If at block 406 the decision is made to proceed to step 408, then the HOE 304 is divided into separate masks for each of the one or Bessel light beams 308 that are to be created. The method then proceeds to step 410 where each of the separate masks are tiled.

However, if at block 406 the decision is made to proceed to step 412, then multiple singularities are nested within the HOE 304.

Regardless of the decision made, following both steps 410 and 412, the method proceeds to step 414 where the HOE 304 initiates one or more wavelength specific response from the light beam 306.

The method then proceeds to step 416 where the one or more wavelength specific responses are used to convert the light beam 306 into the one or more Bessel light beams 308.

It is intended that the Detailed Description section of this patent document, and not the Abstract section, is intended to be used to interpret the claims. The Abstract section may set forth one or more, but not all exemplary embodiments, of the invention, and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the invention. Thus the invention should not be limited by any of the above-described exemplary embodiments, but should be defined only in accordance with the following claims and their equivalents.

What is claimed is:

1. A transceiver device, comprising:
one or more light sources configured to emit a light beam that includes one or more different wavelengths;
a diffractive optical element configured to initiate one or more wavelength specific responses from the light beam to form one or more transmission light beams and to direct the one or more transmission light beams substantially towards a target; and
one or more sensor devices configured to receive the one or more transmission light beams and one or more reception light beams that are reflected back from the target.

2. The transceiver device of claim 1, wherein the diffractive optical element includes one or more holographic optical elements.

3. The transceiver device of claim 2, wherein the one or more holographic optical elements are each configured to perform a plurality of optical tasks.

4. The transceiver device of claim 2,
wherein the one or more holographic optical elements include a first holographic optical element and a second holographic optical element, and
wherein the first holographic optical element is configured to initiate the one or more wavelength specific responses from the light beam, and
wherein the second holographic optical element is configured to initiate the one or more wavelength specific responses from the one or more transmission and reception light beams.

5. The transceiver device of claim 2, wherein one of the one or more holographic optical elements is configured to invoke the plurality of wavelength specific responses on both the light beam and one or more transmission light beams.

6. The transceiver device of claim 2, wherein one of the one or more holographic optical elements is configured to invoke the plurality of wavelength specific responses on both the light beam and one or more reception light beams.

7. The transceiver device of claim 1, wherein the one or more light sources and the one or more sensor devices are configured to form a monostatic configuration.

8. The transceiver device of claim 1, wherein the one or more light sources and the one or more sensor devices are configured to form a bistatic configuration.

9. The transceiver device of claim 1, wherein the one or more light sources and the one or more sensor devices are configured to form a multistatic configuration.

10. The transceiver device of claim 1, wherein at least one of the one or more light sources, the diffractive optical element, and the one or more sensor devices are formed as a LIDAR system in a photonic integrated circuit.

11. The transceiver device of claim 1, further comprising an optical directive element configured to direct the light beam to the diffractive optical element, and to direct the one or more transmission light beams to the one or more sensor devices.

12. The transceiver device of claim 1, wherein the light beam, the one or more transmission light beams, and the one or more reception light beams have wavelengths in the range of approximately 800 nanometers to approximately 2100 nanometers.

13. The transceiver device of claim 1, further comprising:
one or more filter assemblies configured to filter out ambient light and to filter out specific wavelengths contained within the light beam; and
one or more lenses configured to focus, magnify, and direct the one or more transmission light beams and the one or more reception light beams towards the one or more sensor devices.

14. The transceiver device of claim 1, further comprising one or more light waveguides configured to direct light beams between the one or more light sources, the one or more sensor devices, and the diffractive element.

15. An optical system, comprising:
a multi-wavelength light sources configured to emit a light beam that includes one or more different wavelengths; and
a diffractive optical element configured to initiate one or more wavelength specific responses from the light beam to form one or more transmission light beams;
wherein the diffractive optical element is configured to diffract the one or more different wavelengths such that each of the one or more different wavelengths have a pre-selected focal distance and angular deflection.

16. The optical system of claim 15, wherein the diffractive optical element includes a holographic optical element.

17. The optical system of claim 15, wherein the optical system is configured to withstand storage temperatures in the range of approximately −60° C. to approximately 85° C.

18. The optical system of claim 15, wherein the optical system is configured to withstand operating temperatures in the range of approximately −60° C. to approximately 70° C.

19. The optical system of claim 15, wherein the optical system is configured to meet Mil-spec 883 F standards for mechanical vibration, temperature, humidity and IP65 rating.

20. The optical system of claim 15, wherein the light beam and the one or more transmission light beams have wavelengths in the range of approximately 800 nanometers to approximately 2100 nanometers.

21. A method for converting, within a transceiver device, a Gaussian light beam into one or more Bessel light beams, comprising:
generating a first light beam that includes the Gaussian light beam;
receiving the first light beam, over a fiber optic, at a holographic optical element;
initiating, by the holographic optical element, one or more wavelength specific responses from the first light beam; and
converting, using the one or more wavelength specific responses, the first light beam into a second light beam having a ring configuration,
wherein the second light beam includes the one or more Bessel light beams.

22. The method of claim 21, further comprising:
receiving the second light beam, including the one or more Bessel light beams, at the holographic optical element;
initiating, by the holographic optical element, the one or more wavelength specific responses from the second light beam; and
converting, using the one or more wavelength specific responses, the second light beam into the first light beam that includes the Gaussian light beam.

23. The method of claim 21, wherein the one or more Bessel light beams are configured to have intensities that are highest near a central axis of the holographic optical element, and wherein the intensities diminish as a distance from the central axis of the holographic optical element increases.

24. The method of claim 21, wherein the converting is performed by dividing the holographic optical element into separate masks for each of the one or more Bessel lights beams to be created, and tiling each of the separate masks.

25. The method of claim 21, wherein the converting is performed by nesting multiple singularities within the holographic optical element.

26. The method of claim 21, wherein a propagation distance of the one or more Bessel light beams is proportional to a size of the holographic optical element.

27. The method of claim 21, wherein the one or more Bessel light beams have greater intensities than a Bessel beam created using a non-holographic element.
